(19) United States
(12) Patent Application Publication
(10) Pub. No.: US 2015/0068782 A1
(43) Pub. Date: Mar. 12, 2015

(54) PERCUSSION DEVICE

(71) Applicants: Markus Mellwig, Hagen (DE); Uwe Autschbach, Oberhausen (DE)

(72) Inventors: Markus Mellwig, Hagen (DE); Uwe Autschbach, Oberhausen (DE)

(21) Appl. No.: 14/376,019

(22) PCT Filed: Apr. 5, 2013
(86) PCT No.: PCT/DE2013/000178

§ 371 Date: Jul. 31, 2014

(30) Foreign Application Priority Data
May 23, 2012 (DE) 102012010094.9
Jul. 5, 2012 (DE) 102012013409.6

(51) Int. Cl. B25D 9/14

(52) U.S. Cl. CPC B25D 9/14
USPC 173/90

(57) ABSTRACT

The invention relates to a percussion device comprising a percussion mechanism housing which has a receiving bore in which a percussion piston is mounted such that it is movable along the longitudinal axis, wherein at least one percussion mechanism guide surface having an inner diameter is formed in the receiving bore and at least one percussion piston guide surface having an outer diameter is formed on the percussion piston. In order to avoid radial contact between the percussion piston and the percussion mechanism housing as far as possible, to reduce the volume of oil leakage through the gap of the guide surface and to prevent wear on the guide surfaces and on the lands between the seals, according to the invention the percussion mechanism guide surface has, at least in some regions, an inner diameter that increases non-linearly in the axial direction and/or the percussion piston guide surface has an outer diameter that decreases non-linearly in the axial direction.

The present invention relates to an impact tool with a percussion mechanism housing having a receiving bore in which a percussion piston is mounted such that it is movable along the longitudinal axis, wherein at least one impact mechanism guide surface having an inner diameter is formed in the receiving bore and at least one impact piston guide surface having an outer diameter is formed on the impact piston.

Impact tools operated by pressurized medium are used in hydraulic hammers, which serve in particular for breaking up stone, concrete or other building materials, and in boring hammers that serve for boring holes in stone and other building materials. In most cases they are installed as additional or add-on apparatuses on construction machines, such as for example excavators, loaders, caterpillar track vehicles or other support units, and are supplied with work fluid from these.

In the case of hydraulic hammers that are driven by oil as the work fluid, the impact mechanism is connected hydraulically to the pump or tank of for example an excavator via a pressure line and a tank line. An impact piston that is guided in the impact mechanism housing has two oppositely directed drive faces that are connected by a control valve (control slide) to the pressure or tank line so that the impact piston repeatedly executes to and fro movements wherein in one direction of movement the piston at the end of its stroke, the impact stroke, strikes a tool such as by way of example a chisel, a bore rod or an impact member. In normal operation the support apparatus presses the impact mechanism in the direction of the material that is to be processed so that the lower tool end is pressed against the material that is to be processed.

The energy that is introduced into the tool by the impact piston striking the tool causes a high impact force that is transferred from the tool to the material and causes a break-up of the material.

The impact piston normally comprises two piston rods with different diameters and has one or more piston collars arranged between the rods and each having a cylindrical outer shell surface. The impact piston is guided in a stepped receiving bore of the impact mechanism housing which (bore) is adapted to correspond with the impact piston diameter, wherein the inner diameters of the receiving bore in the region of the guides are made slightly larger than the corresponding outer diameters of the impact piston. Since the guide surfaces that are thus formed each have a cylindrical shape, a gap of constant height is formed at the guide regions between the component parts.

If a volume of oil is located at both ends of the gap, then a volumetric stream of oil flows through the gap dependent on the pressure difference between the oil volumes. If the impact piston is moved in the receiving bore of the impact mechanism housing along its axis of symmetry relative to the impact mechanism housing, then as a result of the friction and adhesion forces between the oil and the surfaces of the component part a transport of oil through the gap additionally takes place. As a result of these processes an oil pressure is set in the gap that is dependent on the pressure difference between the oil volumes and the speed of movement of the impact piston. The pressure of the oil in the gap causes a radial force, acting over the periphery, on the piston and presses it away from the bore wall whilst exerting a centering effect on the impact piston.

The guide surfaces of the impact piston and/or the receiving bore of the impact mechanism housing can have peripheral pressure compensating grooves with a width and depth of approximately 1 mm to 3 mm each, in order to distribute the oil uniformly over the periphery of the guide surfaces and thus to ensure in the peripheral direction a pressure compensation on the guide surfaces. The pressure compensating grooves have a radius in the groove base and groove flanks arranged perpendicular to the guide surface. This pressure compensation reduces the one-sided deflection of the impact piston transversely to its axis of movement that would arise as a result of pressure differences.

The chisel of the hydraulic hammer is mounted by bearing bushes in the lower region of the impact mechanism housing, wherein in the new condition there is a slight play between the chisel and the bearing bushes, i.e. the chisel can be set slightly inclined whereby the chisel axis no longer runs parallel to the axis of the bearing bushes. The play and thus the inclined position can increase more through wear on the chisel and the bearing bushes. This inclined position has the result that the end sides of the impact piston and chisel are no longer aligned exactly parallel to one another and the contact surface that forms as the lower piston end face strikes the upper chisel end face does not lie centrally relative to the impact piston axis. A force is thereby exerted during impact on the impact piston which (force) acts eccentrically to the impact piston axis and generates a transverse force that deflects the impact piston.

The mutually contacting end faces of the impact piston and/or chisel are provided in part with chamfers or have a concave contour having a large radius in comparison with the diameter of the chisel in order to reduce the eccentricity in the event of an oblique position and to reduce the surface pressure during impact.

With special coatings on the guide surfaces of the component parts intending to increase the wear-resistance, it is endeavored either by increasing the surface hardness, by reducing the friction or by smoothing the surfaces, to reduce the wear that is caused by the contact of the component parts. Such coatings can be by way of example diamond-like carbon layers, graphite layers or molybdenum disulphide layers.

In KR 10-2011-0086289 an impact piston is described in which the inner surface has in the lower part of the cylinder a plurality of equidistantly spaced grooves and in which the inner surface is formed as an inclined surface, wherein the bore widens continuously from the uppermost groove to the lowermost groove. The bore widens with a constant pitch angle of 0.001 to 0.50, with the diameter thus changing linearly to the distance from the upper groove.

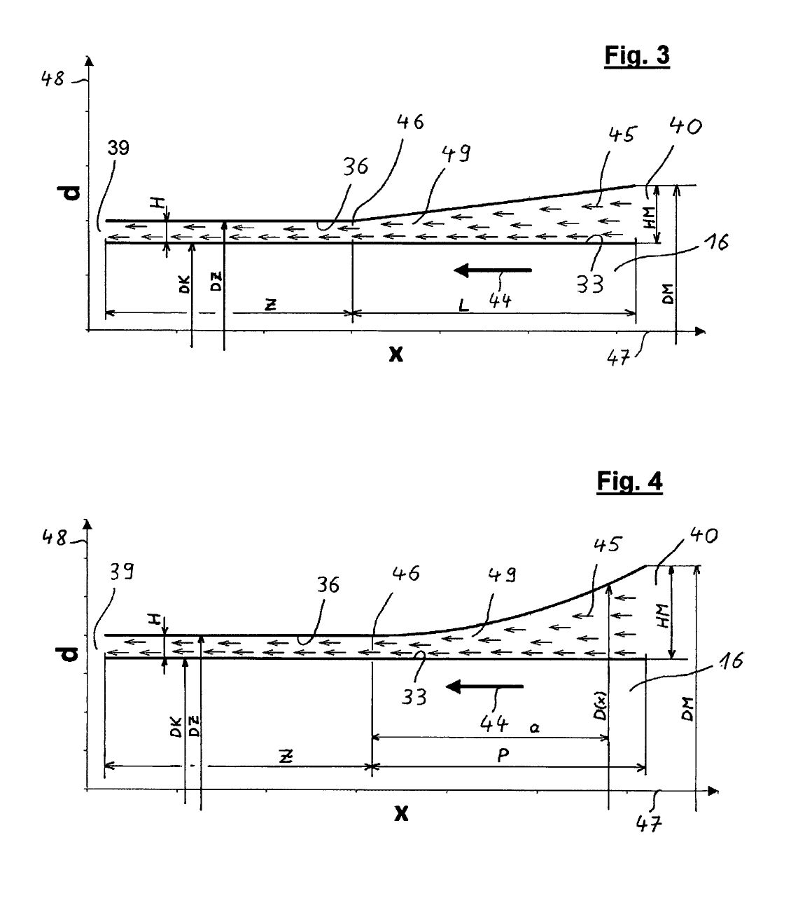

Seen in the impact stroke direction the actual guide region with the widening bore is adjoined at the back by a region that in addition to a triangular-shaped groove has three grooves for receiving seals (see FIG. 3 of KR 10-2011-0086289). The webs between the seals are configured so that their inner diameter corresponds to the smallest diameter of the bore and is thus smaller than the largest diameter of the widening bore.

The drawback with the impact tools known according to the prior art is that the force, which as a result of an inclined position of the chisel acts eccentrically during the impact of the impact piston, creates between the end faces of the impact piston and chisel a transverse force on the impact piston from which results a displacement transversely to the axis of symmetry of the impact piston. A displacement can also occur through transverse accelerations of the impact mechanism housing when transverse forces act on the housing and the latter is displaced relative to the impact piston. In the case of a cylindrical design of the guide surfaces on the impact piston and on the impact mechanism housing the oil pressure in the gap between the impact piston and the receiving bore is often not sufficient to prevent contact between the impact piston and the impact mechanism housing. Also the convex shaping of the end faces, the use of pressure compensating grooves or the use of coatings on the component parts are often not sufficient to adequately reduce the transverse force in order to prevent contact between the impact piston and the guide surfaces, and to reduce the wear. If the load-bearing capacity of the oil film in the gap between the guide surfaces and that is dependent on the oil pressure is thus exceeded then the result is contact between the impact piston and the impact mechanism housing, whereby the guide surfaces can be plastically deformed and can become scratched.

Through the cylindrical design of the guide surfaces, in the event of an oblique position where the axis of symmetry of the impact piston no longer runs parallel to the axis of symmetry of the receiving bore of the impact mechanism, the impact piston respectively bears against an edge whereby a contact point is produced with a high surface pressure that leads to damage and wear. Apart from an oblique position the piston can also become deformed as a result of transverse forces so that the axis of symmetry no longer runs in a straight line and one or both ends are temporarily bent outward.

As a result of the axial movement of the impact piston in relation to the impact mechanism housing, friction occurs when these surfaces come into contact whereby heat is generated that is in part so high that the surfaces of the component parts locally weld together and material is torn out from one of the component parts at these places and firmly adheres to the surface of the component parts of the other component part. If this material is drawn over the guide surfaces then the adhering and protruding material leads to further rapidly developing damage to the surfaces, which leads to the breakdown of the impact mechanism and to oil leaks.

Even in the case of the impact tool according to KR 10-2011-0086289, in the event of an oblique position of the impact piston in the bore the impact piston in a disadvantageous manner comes into contact with the upper edge of the bore (above the groove (8a)), since the angle is selected so that the impact piston does not come into contact with the regions between the groove (8a) and the groove (32). By bearing against the upper edge only a very small contact surface is provided between the impact piston and the bore whereby high surface pressures arise that lead to corresponding damage and wear on the contact surfaces of the piston and bore.

Through the inner diameter of the webs in the region of the seals that is smaller compared with the largest inner diameter of the bore, in the event of an oblique position of the impact piston in the housing or in the event of deformations of the impact piston, the impact piston bears against the webs. The guide surfaces of the impact piston and the web faces thereby become damaged.

The gap between the bore and the impact piston is furthermore to act as a sealing gap that is to prevent large amounts of oil from flowing through the gap and to a pressure relief groove lying behind the gap. The throttle action of the sealing gap is to ensure that the pressure peaks that occur in the groove 33 and that continue to grow in the gap, do not act at the end of the gap to the full extent on the seals 31. Through the continuous expansion of the bore over its entire axial extension the throttle action of the guide is reduced detrimentally that leads to a high volume leak and to the presence of high pressure peaks at the seals. The high volume leak impairs the efficiency of the hydraulic hammer.

Furthermore through the non-existing cylindrical region of the bore, which would have a constant diameter, the load-bearing capacity of the oil film forming in the gap is reduced that leads to contact between the impact piston and the bore and to damage and wear on the guide surfaces.

The object of the present invention is to overcome the above-described disadvantages and to substantially avoid any radial contact between the impact piston and the impact mechanism housing. Furthermore the volume of the oil leak flowing through the gap of the guide surfaces is to be reduced. More particularly the wear on the guide surfaces and on the webs between the seals is to be prevented.

This object is achieved through the impact tool according to claim 1 according to which in accordance with the invention it is provided that the impact mechanism guide surface has in the axial direction at least in regions an inner diameter that increases non-linearly and/or that the impact piston guide surface has an outer diameter that decreases non-linearly in the axial direction. In order to increase the load-bearing capacity of the oil film in the gap between the guide surfaces, the guide surfaces of the impact piston or of the impact mechanism housing are designed accordingly so that a partial area of the shell surface of at least one guide surface has an inner diameter that increases non-linearly in the axial direction at least toward one end of the guide surface, or an outer diameter that decreases non-linearly in the axial direction. The increase in the inner diameter or the decrease in the outer diameter is preferably configured as parabolic.

Through the configuration according to the invention it is prevented that in the event of an inclined position of the impact piston in the receiving bore, or deformations, the impact piston guide surface comes into contact into contact with the regions of the bore and causes damage and wear.

If in the case of a non-cylindrical impact mechanism guide surface the impact piston moves toward the tapering gap, or in the event of a non-cylindrical impact piston guide surface the impact piston moves toward the widening gap, then as a result of the friction between the oil and the surfaces of the component part the oil is transported into the narrowing gap. The oil pressure in the narrowing gap thereby clearly rises compared with a purely cylindrical design, which also causes a rise in pressure in the adjoining area having a constant gap height. This increased oil pressure ensures that sufficient radial force acts on the impact piston and that the load-bearing capacity of the oil film has been clearly improved and is now sufficient to hold the piston at a distance from the impact mechanism housing. Since no more contact occurs between the moving component parts, the wear and the damage to the guide surfaces are effectively reduced or avoided, and the service life of the impact mechanism is increased.

Tests have shown that a non-linear and in particular a parabolic diameter change is substantially more effective at preventing contact between the impact piston and the impact mechanism, than a linear diameter change, and thus the wear on the component parts can be more significantly reduced through the non-linear or parabolic diameter change than in the case of a linear diameter change.

Particularly in the case of a return stroke after which the impact piston experiences a transverse force after striking the chisel, the formation of a better load-bearing lubricating film is obtained through the non-linear diameter change, whereby the damage to the guide surfaces, the lower piston rod and the corresponding guide surface of the impact mechanism housing is prevented.

Similarly effective is the diameter change at the impact piston guide surfaces wherein both ends of the respective piston collar are designed with a diameter that is reduced compared with the middle cylindrical region. The piston collars thereby have an approximately barrel-shaped outer contour that ensures increased load-bearing capacity of the lubricating film in both directions of movement. In the case of several piston collars it is also possible to provide each time only the ends of the outer piston collars pointing toward the piston rods, with a reducing diameter.

The configuration according to the invention can dispense with the use of expensive, complicated and in part environmentally damaging coatings.

Through the region with changing diameter that extends only over a restricted axial length of the guide surface, a cylindrical region remains having a constant diameter and a small gap height, whereby the volume of leakage flowing through the gap is reduced, compared with a design in which the diameter changes over the entire length of the guide surface, and the height of the pressure peaks supplied through the gap is reduced. More particularly at the impact mechanism guide surfaces an increase in the diameter only within a partial region leads to a reduction in the flow volume of the leak and in the pressure peaks.

In addition, through the widening diameter it is achieved that in the case of an oblique position of the impact piston in the housing, where the axis of the impact piston no longer runs parallel to the axis of the guide, or in the event of deformations of the impact piston, wherein the ends of the piston rods are curved outward, the impact piston comes to bear against not only the angular inner edges of the guide surfaces of the impact mechanism housing, or the angular outer edges of the guide surfaces of the impact piston, whereby a spot or linear type contact point would arise, but the contact point lies in a region in which the diameter is slightly changed. In the event of a diameter that changes in parabolic fashion, a smooth transition is formed from the cylindrical region to the region having the increasing diameter. A larger contact surface is thereby formed without any edges, which considerably reduces the surface pressure and thus the wear.

The maximum possible angle between the lines of symmetry of the impact piston and the receiving bore cannot be exactly determined since on the one hand as a result of the unavoidable manufacturing tolerances the play between the piston and the receiving bore can vary from impact mechanism to impact mechanism, and furthermore the angle changes during the axial piston movement. In general the maximum theoretically possible inclined position of the impact piston arises from the play between the receiving bore and the impact piston, but also from the axial spacing of the two contact points between the impact piston and the receiving bore. If by way of example the position of the upper contact point were defined by the upper edge of the upper impact piston collar, and the lower contact point by the upper edge of the guide surface of the impact mechanism housing for guiding the lower rod, then the upper contact point would be moved along with the impact piston, but the lower contact point would remain fixed relative to the impact mechanism housing, whereby the axial spacing of the contact points is changed during axial movement of the impact piston, which likewise changes the maximum inclined position. A change in angle would be seen if the contact points were connected by a straight line. If the piston is moved downward in the impact stroke direction in the event of the position of the contact points described above, then the length of the line is reduced, but the angle to the axis of symmetry of the receiving bore is increased. Thus it is not possible to execute a linear change in diameter on a guide surface so that the surface in the region of the linear diameter change is constantly supporting over its entire length. If the angle changes, then the contact point moves to one end of the guide surface, whereby an edge forms the contact point at this guide surface. In the case of a non-linear and more particularly in the case of a parabolic diameter change, the rounded, non-linear or parabolic region is always supporting in the event of a corresponding design.

As a result of the diameter in the region of the webs between the sealing grooves and between the sealing groove and the pressure compensating groove, or impact chamber, being greater compared with the adjoining impact mechanism guide surface, damage to and wear on the surfaces of the webs and the impact piston are prevented, since the impact piston can no longer come into contact here.

Preferred embodiments of the present invention will be described below and in the dependent claims.

According to a first preferred embodiment it is proposed that the inner diameter of the impact mechanism guide surface has a diameter that increases non-linearly at least toward one of the ends. An impact mechanism guide surface of this kind preferably guides a piston rod wherein the inner diameter of the impact mechanism guide surface has a diameter that increases non-linearly toward the outer end of the piston rod.

Impact mechanisms of the type described can comprise one or more impact mechanism guide surfaces wherein not all the impact mechanism guide surfaces of one impact mechanism need have the configuration according to the invention. It is also possible that in the case of an embodiment having two or more mutually spaced impact mechanism guide surfaces only one or one part of the impact mechanism guide surfaces has the features according to the invention. The configuration according to the invention is preferably used at least on the guide of the lower piston rods where a partial region of the guide surface of the impact mechanism housing has a parabolically increasing diameter, wherein the diameter increases toward the lower end of the guide and a tangential transition to the region having constant diameter is formed. The piston rod is designed cylindrical in the region of the guide surface. A parabolic increase in diameter thereby means that the diameter does not increase linearly, but over-proportionally to the axial spacing from the upper edge of the guide, or from the transition of the cylindrical guide region to the widening guide region. In the case of a cross-section through the center axis of the guide, the path of the inner edge of the guide surface in the impact mechanism housing represents in part a parabolic line.

According to a further preferred embodiment of the invention it is proposed that the impact mechanism guide surface has several partial regions wherein one partial region has a non-linearly increasing inner diameter, which merges into one partial region with a constant inner diameter. Furthermore at the end of the partial region having the largest diameter there is a partial region arranged with a linearly widening inner diameter, and at the end of the partial region having the smallest diameter there is a partial region provided with a constant diameter.

Finally according to a preferred configuration of the impact mechanism guide surface it is proposed that partial regions are arranged on each side that have partial regions widening non-linearly in different orientation, wherein the partial regions are preferably connected to one another via a partial region with a constant diameter.

The configuration of guide surfaces according to the invention is provided not only in the case of impact mechanism guide surfaces but also in the case of impact piston guide surfaces. The impact piston preferably has here at least one piston rod and at least one piston collar whose outside surfaces are formed as impact piston guide surfaces. In other words, the embodiment according to the invention is also applied to the guide surface of the piston collar or piston collars, wherein the guide surface is designed cylindrically in the impact mechanism housing, but the guide surface of at least one piston collar has a diameter that decreases at least toward one end. The diameter preferably decreases parabolically, seen in the axial direction, and with a tangential transition to a region of constant diameter. If the guide surface of the piston collar has on both sides a parabolically decreasing diameter, which is preferably proposed, then the piston collars have an approximately barrel-shaped outer contour.

In other words, at least one impact piston guide surface preferably has on the side facing away from the tool an outer partial region having a non-linearly decreasing outer diameter that preferably runs parabolically and/or preferably changes into a partial region with a constant diameter. The impact piston guide surface can hereby have two outer partial regions that have outer diameters that decrease non-linearly in different orientation and preferably run parabolically. According to a particularly preferred embodiment it is proposed that a partial region with a constant diameter is arranged between the outer partial regions.

Furthermore according to a preferred embodiment of the invention it is proposed that the impact mechanism has an impact mechanism guide surface that guides a piston rod, wherein a tool can be loaded with the outer end of the piston rod, and wherein the inner diameter of the impact mechanism guide surface has a partial region with a constant diameter and pointing toward the outer end of the piston rod, a partial region with a parabolically increasing diameter, and that at least one impact piston guide surface has a partial region with a constant diameter and on the side facing away from the tool, an outer partial region having a parabolically decreasing outer diameter.

Furthermore, the inner diameter of the webs inside the receiving bore for the impact piston is designed larger in the region of the seals and the pressure compensating groove than the smallest inner diameter of the guide region for the piston rod and preferably larger than the largest diameter of the guide region.

The impact mechanism guide surface is adjoined here at least by a region in which there are peripheral grooves arranged wherein the webs between the grooves and the region between a groove and a space arranged behind same have an inner diameter that is greater than the small inner diameter of the guide region.

Concrete illustrated embodiments of the present invention will now be explained below with reference to the drawings, in which:

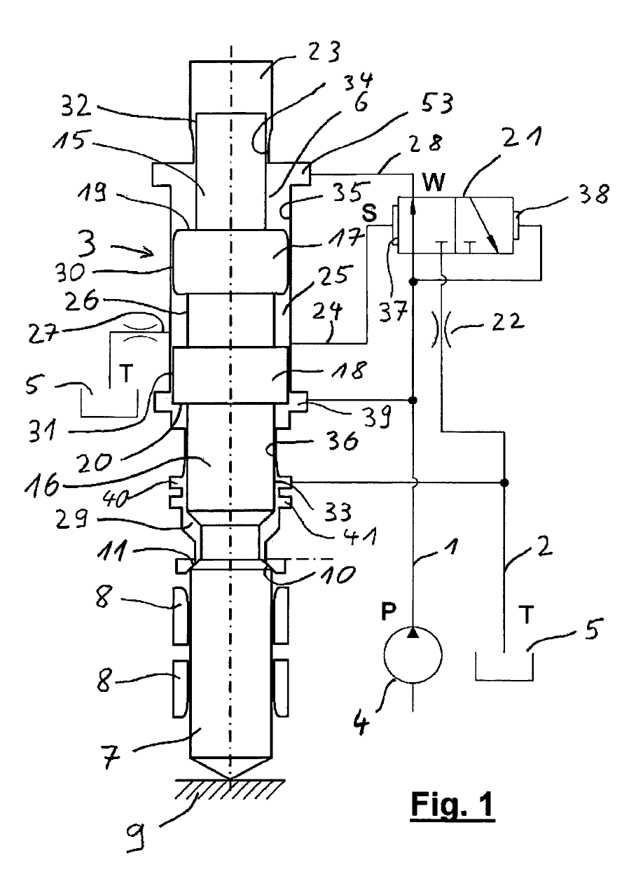

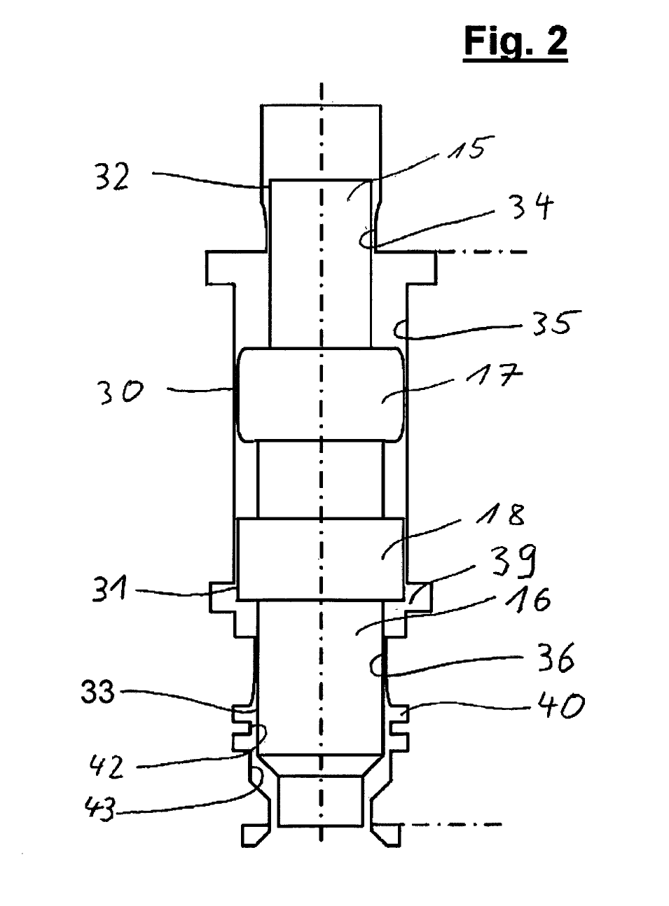

FIGS. 1 and 2 show diagrammatic illustrations of an impact mechanism having an impact piston,

FIGS. 3 to 7 show different designs of impact mechanism guide surfaces,

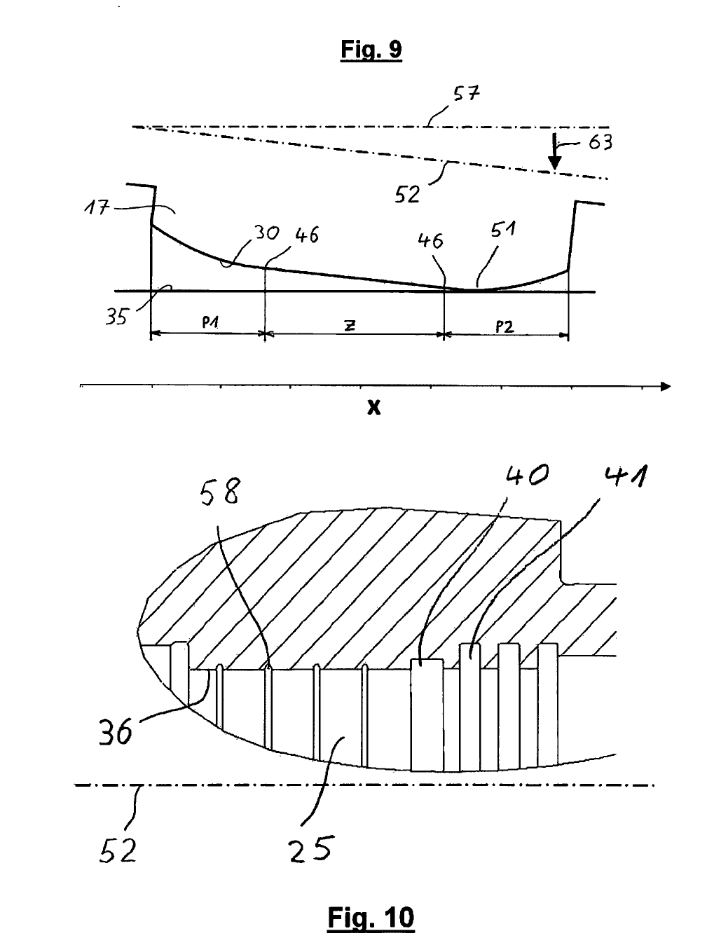

FIGS. 8 and 9 show different illustrations of an impact piston guide surface,

FIG. 10 shows a detail view of an impact mechanism, and

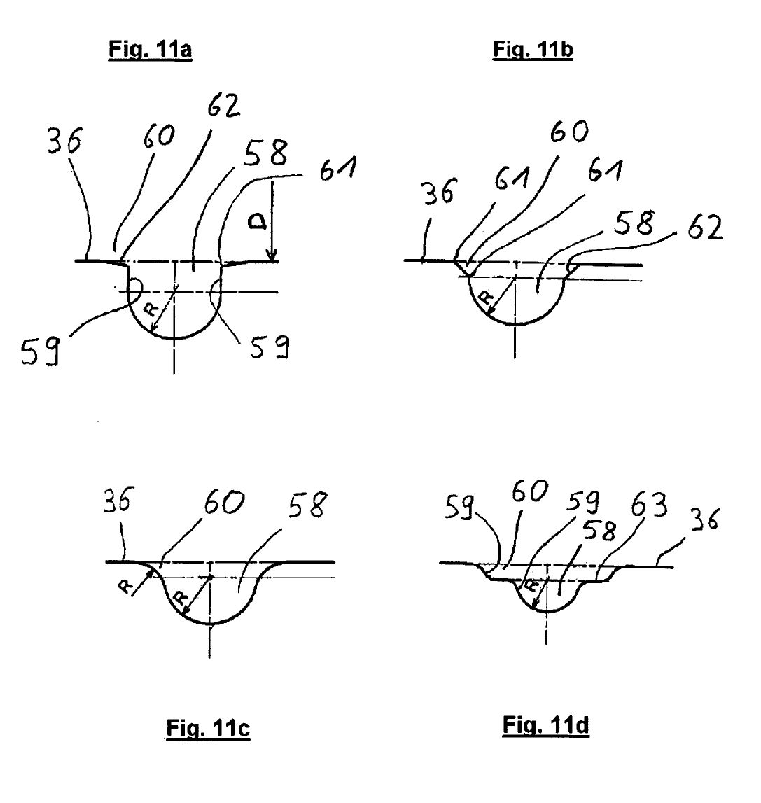

FIGS. 11a to 11d show different detail views of pressure compensating grooves.

The operating mode of a hydraulic impact tool is illustrated diagrammatically in FIGS. 1 and 2. The impact mechanism 3 is connected hydraulically to the pump 4 and tank 5 respectively of a support apparatus, by way of example an excavator, via a pressure line 1 as well as a tank line 2. On the excavator there is a valve to which the line 1 to the pump can be connected in order to supply pressurized oil to the impact mechanism for operation, or the connection can be separated in order to stop the operation of the impact mechanism. This valve is not shown to improve clarity.

The impact mechanism 3 consists of an impact mechanism housing in which an impact piston 6 is guided. The impact mechanism housing can be made up of several component parts connected by screws, such as a cylinder lid, a cylinder and a chisel socket in which the chisel 7 is mounted by means of bearing bushes 8. Only illustrated is the simplified inner contour of the receiving bore of the impact mechanism housing in which the impact piston 6 is guided. In FIG. 2 horizontal chain-dotted lines are added to show by way of example the possible separating points between the cylinder lid and the cylinder, and between the cylinder and the chisel socket respectively. Such a separation is also required in order to insert the impact piston into the receiving bore. The cylinder is located between the chain-dotted lines.

During normal operation, the support apparatus presses the impact mechanism in the direction of the material 9 to be processed so that the impact mechanism is supported on a contact bearing face 11 of the upper chisel end via the chisel stop 10 arranged in the housing, and the lower chisel end is pressed against the material to be processed.

During normal operation the hydraulically driven impact piston 6 at the end of each impact stroke strikes against the end of the chisel located in the impact mechanism thereby transferring its kinetic energy to the chisel. The energy introduced into the chisel creates a high impact force that is transferred from the chisel to the material and causes the latter to break up.

The impact piston 6 has two piston rods 15, 16 between which there are arranged two piston collars 17, 18. The piston collars 17, 18 each form on the side pointing toward the respective rod oppositely directed annular drive faces 19, 20 that have different surface areas as a result of the different rod diameters. The lower drive face 20 via that when pressure is applied the return stroke is triggered during which the impact piston is moved upward away from the chisel, is permanently charged with the pump pressure that prevails in the pressure line 1 during the operation. The upper drive face 19, via which when pressure is applied the impact stroke is triggered during which the impact piston is moved toward the chisel, is charged with the pump pressure or relieved to the tank depending on the position of a control valve 21, by a connection being made with either the pressure line or tank line. The impact stroke is possible since the upper annular drive face 19 has a larger surface area than the lower face 20 so that in the event of both faces being charged with the pump pressure a resulting force directed toward the chisel acts on the impact piston 6. The moving impact piston 6 during the so-called impact stroke displaces the oil, which is displaced from the small lower drive face, in the direction of the larger upper drive face 19 of the impact piston 6 to which the oil coming from the pump 4 also flows. During the return stroke the oil flows from the pump 4 solely in the direction of the smaller surface lower drive face 20, whilst the oil from the larger surface upper drive face 19 is discharged to the tank 5 via a return throttle 22 that ensures smooth running of the hammer.

The impact mechanism has a gas reservoir 23, namely a space that is under gas pressure and into which the upper rod 15 of the piston projects. The gas pressure in this space exerts on the piston an additional force that acts in the direction of the impact stroke. The other lower rod projects into a so-called impact chamber 29 that is connected to the atmosphere.

The control valve 21 that is preferably located in the cylinder lid, the cylinder or a valve block that is fixed on the cylinder lid or cylinder, depending on the switched position connects the larger surface upper drive face 19 either to the pressure line 1, so that the operating pressure acts there, or during the return stroke relieves this face via the tank line 2 to the tank 5.

The control valve 21 can also similar to the impact piston have two drive faces wherein a first face 38, the resetting face, is constantly charged with the pump pressure via the pressure line, and a second face 37, the control face, which has a larger surface area and is directed oppositely to the first face, is selectively charged with the pump pressure or relieved to the tank 5. Through the different sizes of the two faces the control valve can be moved into one of its end positions with corresponding pressure loading of the faces.

The control face 37 is connected to a reversing line 24 that opens into the receiving bore 25 in which the impact piston 6 is guided so that, depending on the position of the impact piston 6, it is loaded with the pump pressure or relieved to the tank 5. In the lower reversing position in which the impact piston in the normal operating state strikes the tool as illustrated in FIG. 1, the opening of the reversing line 24 is connected via a peripheral groove 26 arranged between the piston collars to a tank line 27 likewise opening into the receiving bore and in which a low pressure prevails whereby the control face of the control valve is relieved to the tank 5 and the control valve occupies a first end position (return stroke position), since the high pump pressure arises on the resetting surface of the control slider and generates a corresponding resetting force. The tank lines 2, 27 are brought together inside the impact mechanism and open into a common tank of the support apparatus, which for clarity is shown here as two tanks. In the return stroke position the control valve connects the upper drive face 19 of the impact piston to the tank line 2 via the alternating pressure line 28. As a result of the pump pressure constantly arising on the lower drive face 20 of the impact piston, the impact piston is displaced upward against the impact stroke direction. The oil displaced from the upper piston drive face 19 flows in a throttled fashion via a return throttle 22 to the tank whereby during the return stroke a pressure level required for smooth running is maintained on the upper drive face.

If the impact piston 6 moves upward out from the lower reversing position during the return stroke then the lower piston collar 18 first covers the reversing line 24 that opens into the receiving bore in order to release it after a piston travel that represents the nominal piston stroke, close to the upper reversing point to the lower drive chamber 39. Since the lower drive chamber is connected to the pressure line 1 in which the pump pressure is arising, this pump pressure now acts also in the reversing line 24 and on the control face 37 of the control valve 21. Since the control face 37 has a larger surface area than the resetting surface 38, despite the same pressure on the two surfaces a resulting force acts on the control valve to switch it into the different end position (impact stroke position). The control valve now connects the upper drive face 19 of the impact piston to the pressure line 1 via the alternating pressure line 28. Since the upper drive face 19 has a larger surface area than the lower drive face 20 and despite the same pressure on the two surfaces a resulting force acts on the impact piston to accelerate it in the impact stroke direction and onto the chisel. During the impact stroke the piston again covers the reversing line and connects this, as described above, via the peripheral groove 26 to the tank line 27 again, shortly before the piston strikes the chisel. A return stroke then takes place again, and so on.

In the illustrated design the impact piston has an upper piston rod 15, a lower piston rod 16 and two piston collars 17, 18 between that is arranged a peripheral groove 26. It is also possible to use only one or also more than two piston collars and instead of the peripheral groove to use grooves arranged axially on the rod or a piston collar or several piston collars, or radial bores. The peripheral groove, grooves or bores are required to undertake the control functions, wherein depending on the position of the impact piston relative to the impact mechanism housing the peripheral grooves or bores located in the impact mechanism housing are connected to one another or are separated via the grooves or bores that are located on the impact piston.

The impact piston or the cylinder bore of the housing can have peripheral pressure compensating grooves in order to distribute oil evenly over the shell surface of the piston and thus to ensure a pressure compensation in the peripheral direction on the shell surface.

The impact piston is guided over the impact piston guide surfaces 30 and 31 on the piston collars 17, 18 and over the impact piston guide surfaces 32 and 33 on the rods 15, 16 that have a slightly smaller outer diameter than the inner diameter of the corresponding impact mechanism guide surfaces 34 and 36 for guiding the rods and the impact mechanism guide surface 35 for guiding the piston collars 17 and 18.

If the impact piston has more than two guide places, then through suitably selecting the inner and outer diameters of the respective guide surfaces it is possible to determine that guide places limit the maximum inclined position of the impact piston in the receiving bore, and which maximum inclined position is permitted.

The receiving bore in the impact mechanism housing can—as illustrated—represent directly the impact mechanism guide surfaces for the impact piston, but alternatively sleeve-like guide bushes can also be used that are arranged with a slight play around the impact piston and are inserted with their outer shell surfaces in the receiving bore of the impact mechanism housing. If such is guide bushes are used for guiding the piston rods, then these can have at the same time peripheral grooves on the inner shell surface in which seals are inserted in order to prevent the outflow of gas or work fluid along the piston rods.

The receiving bore has peripheral grooves in the region of the guide of the lower piston rod 16. The pressure relief groove 40 arranged underneath the impact mechanism guide surface 36 is connected to the tank line 2 in order to discharge to the tank the oil that coming from the lower drive chamber flows through the guide gap between the impact piston guide surface 33 and the impact mechanism guide surface 36.

A sealing groove 41 is located underneath the pressure relief groove and contains a seal (not illustrated) in order to prevent the outflow of work fluid from the lower drive chamber into the impact chamber 29. In addition to the sealing groove 41 one or more sealing grooves can also be arranged underneath the pressure relief groove to receive a second seal and to receive a scraper that prevents dirt from the impact chamber from entering into the guide region. In addition a pressure relief groove can also be provided between the sealing grooves.

The pressure relief groove can also be connected via a throttle to the tank line or to the pressure line. This pressure relief valve is to prevent the pressure peaks that appear in the lower drive chamber from being able to exceed the nominal operating pressure and acting on the seals, which could lead to damage to the seals.

A similar arrangement of sealing grooves and pressure compensating grooves is also used on the upper piston rod 15, but for clarity purposes is not shown. In order to supply oil to the guide surfaces on the upper piston rod during the impact stroke, a pressure relief groove can be arranged between the guide surfaces and the seals and is connected either to the pressure line or to the tank line.

The inner diameter of the bore in the web regions 42 (FIG. 2) between the pressure relief groove and the sealing groove and the bore in the web regions 43 (FIG. 2) between the sealing groove and the impact chamber is designed larger than the largest diameter in the region of the guide surface 36 and is preferably selected to be 0.2 mm to 0.5 mm larger than the smallest diameter of the impact mechanism guide surface 36. This thereby prevents the impact piston guide surface 33 with an inclined position of the impact piston in the receiving bore or deformations from coming into contact with these regions of the bore and causing damage and wear.

A similar type of design can be applied to the upper piston rod wherein the diameter of the web regions at the sealing grooves and pressure relief grooves that are arranged between the guide region 34 and the gas chamber 23 is larger in diameter than the largest diameter of the guide region.

As a result of the small differences in diameter between the respective impact piston guide surface and the impact mechanism guide surface that is opposite thereto, in the event of a concentric position of the impact piston relative to the receiving bore along the guide surfaces a gap is formed between the impact piston and the impact mechanism housing. The diameter of the impact mechanism housing guide surface 34 is designed so that the inner diameter of this guide surface increases upward, i.e. toward the upper end of the impact mechanism guide surface, wherein a first axially extending region has a constant diameter and thus represents a cylindrical guide region. The adjoining second region has a parabolically increasing diameter, i.e. the diameter changes in the second region not linearly, but over-proportionally, relative to the axial distance from the lower edge of the guide, or from the transition of the cylindrical to the widening guide region.

With a cross section through the center axis of the guide the path of the inner edge of the impact mechanism guide in the region of the widening guide region produces a parabolic line, with tangential transition to the cylindrical region.

The impact mechanism guide surface 36 for guiding the lower piston rod 16 is designed similar wherein the diameter increases toward the lower end of the impact mechanism guide surface.

The diameter of the impact piston guide surface 30 at the collar 17 is likewise designed with a changing diameter wherein the diameter reduces from a center region of the guide surface out to both ends of the piston collar in parabolic fashion. The collar thereby has a substantially barrel-shaped outer contour.

In all cases, through the axially changing diameter of a guide surface a gap is produced between the guide surfaces having a varying gap height wherein the gap height increases at least to one end of the guide surface. Through the peripheral grooves arranged in the impact mechanism that are hydraulically connected and filled with oil, the gap between the guide surfaces is likewise filled with oil.

So that the impact piston guide surfaces and the corresponding impact mechanism guide surface do not excessively wear out, which can happen through contact between the guide surfaces, it is necessary that a sufficiently load-bearing lubricating oil film is formed between the guide surfaces. The lubricating film is to center the impact piston as much as possible in the receiving bore and to take up the forces that act radially on the impact piston in order to enable a low-friction and low-wear movement of the impact piston in the receiving bore without resulting in any direct contact between the impact piston and the impact mechanism housing.

If in the case of a cylindrical design of the impact piston guide surface and the impact mechanism guide surface a gap of constant height is present, then the load-bearing capacity of the lubricating film can be exceeded particularly in the case of low relative speeds, severe mechanical transverse accelerations of the impact piston or impact mechanism housing, or other transverse forces. If the load-bearing capacity is exceeded then contact occurs between the guide surfaces, whereby rapid wear appears on the components that leads to a rapid breakdown of the impact mechanism.

If two opposing guide surfaces, which have oil volumes in the form of grooves at both ends, are moved relative to one another, then as a result of the adhesion forces oil remains adhering to the surfaces of the guide surfaces. The adhering oil is carried along and is transported in part into the gap between the guide surfaces. As a result of cohesion forces inside the oil, oil that is located slightly at a distance from the surfaces is likewise transported in part into the gap.

If the impact piston is moved upward in the receiving bore of the impact mechanism housing during the return stroke then, as a result of the adhesion forces and friction, oil remains adhering to the impact piston guide surface 33 and is carried along by the impact piston. The entrained oil is conveyed in the narrowing gap. The adhesion and friction between the oil and the impact mechanism guide surface counteract a return flow of oil in the direction of the pressure compensating groove 40 whereby pressure builds up in the gap.

The pressure path inside the gap is dependent on the pressure difference between the oil volumes in front and behind the gap, on the geometry of the guide surfaces and on the speed of movement of the impact piston. The pressure of the oil in the gap causes a radial force acting over the periphery on the piston and this causes centering of the impact piston in the receiving bore.

Since the pressure level is raised by the design described above of the geometry of the guide surfaces compared with purely cylindrical guide surfaces, the load-bearing capacity of the oil film in the gap increases since the oil pressure exerts a stronger radial force on the impact piston in order to hold it at a distance from the impact mechanism housing. Contact between the impact piston and impact mechanism housing is effectively prevented and wear on the component parts is substantially reduced.

In addition, through the parabolically widening diameter of the impact mechanism guide surface 36 what is achieved is that with an oblique position of the impact piston where the axis of the impact piston no longer runs parallel to the axis of the receiving bore of the impact mechanism housing, the lower piston rod not only comes to bear against the lower inner edge of the impact mechanism guide 36 whereby a spot or linear type contact point would arise, but also bears against a larger surface area. This larger contact surface arises through the parabolic geometry through which the piston rod comes to bear against a slightly curved surface of the impact mechanism guide surface. The surface pressure and the wear at the contact point are thereby clearly reduced.

An over-proportional diameter change as described above can be executed at all guide surfaces 30, 31 of the impact piston and at the impact mechanism guide surfaces 34, 35, 36 wherein it is possible to provide a diameter change only on one side of the gap as shown on the guide surfaces 34 and 36, or on both sides of the guide surface, as shown on the piston collar 17. If the diameter change is provided at the impact piston guide surfaces, then the diameter change is carried out so that the outer diameter decreases at least toward one end of the guide surface, as opposed to the diameter change at the impact mechanism guide surfaces where the inner diameter increases at least toward one end.

The piston collar 18 is shown in FIG. 1 with a constant diameter and represents the prior art wherein this piston collar analogously with the collar 17 can likewise be designed with a variable diameter.

Independently of the design of the diameter change, the outer ends of the guide regions as well as the transitions between the cylindrical guide regions and the region with widened diameter can be provided with radii whereby sharp edges, or angular transitions at the diameter changes are avoided (not shown in FIGS. 1 and 2).

Also the wear on the guide surfaces of the chisel 7 and the bearing bushes 8 can be reduced by parabolic diameter changes at the inner guide surfaces of the bearing bushes. The diameters at the respective end of the bearing bushes pointing toward a chisel end preferably increase parabolically, with decreasing distance from the respective end of the bearing bush. In the case of an inclined position of the chisel in the bushes, the chisel no longer bears against the respective outer edges of the bearing bushes, but against the area with a parabolically increasing diameter, which enlarges the contact surface and reduces the surface pressure and the wear.

FIG. 3 shows a configuration of the impact piston guide surface 33 and the impact mechanism guide surface 36 wherein the illustration shows a section through the impact piston axis and only each one half of the contours symmetrical with the impact piston axis are shown. The contours represent only one section delimited in the direction of the impact piston axis.

The horizontal coordinate axis 47 corresponds to the axis of symmetry of the impact piston and the receiving bore of the impact mechanism housing. The vertical distance between the horizontal coordinate axis and the thick contour lines of the impact piston guide surface 33, and the impact mechanism guide surface 36 respectively, represent the radius of the impact piston, and the receiving bore of the impact mechanism housing, respectively.

The axial extension of the guide region is shown on the horizontal coordinate axis, and the diameter is shown on the vertical axis. The radii, the diameters, the diameter change, the gap height, the axial extension of the guide surfaces, and the position of the transition from the cylindrical region to the widening region do not correspond to the parameters advisable in practice, but are shown not true to scale for better illustrating the inventive idea.

The upper thick line shows the contour of the impact mechanism guide surface 36 between the lower drive chamber 39 and the pressure relief groove 40. The impact mechanism guide surface is designed cylindrically inside an axial region Z, i.e. the diameter DZ, or the distance of the line from the horizontal coordinate axis is constant up to the transition point 46. Inside the region L the diameter of the impact mechanism guide surface 36 increases linearly to the distance from the transition point 46 and reaches its maximum value DM at the end of the impact mechanism guide surface.

The lower thick line represents the contour of the impact piston guide surface 33 and has the diameter DK that is constant at least within the region of the impact mechanism guide surface 36.

The gap height is produced from half the difference of the diameters of the impact mechanism guide surface and the impact piston guide surface, and is marked in region Z by H and reaches the maximum value HM at the right end of the impact mechanism guide surface.

The contours of the regions outside of the impact mechanism guide surface, such as those of the pressure relief groove 40 or the lower drive chamber 39, are not shown here and can have diameters that are larger than the diameter DM or DZ respectively.

The impact piston also has at the side of the illustrated region a constant diameter DK at least over a restricted length.

The arrow 44 marks the movement of the impact piston during which the illustrated design of the guide surfaces causes an improvement in the load-bearing capacity of the lubricating film. The impact piston moves parallel to the horizontal coordinate axis, toward the narrowing gap 49. As a result of the adhesion forces and friction, oil remains adhering to the surface of the impact piston guide surface and is entrained in the direction of the arrow 45. Cohesion forces within the oil ensure that oil is also entrained that is located further away from the impact piston guide surface. Close to the impact piston guide surface the rate at which the oil moves up in the direction of the arrow decreases however as the distance from the impact piston guide surface becomes greater. Since the gap height decreases in the direction of the arrow, the thus entrained oil builds up in the gap that leads to a rise in the pressure that increases the load-bearing capacity of the oil film located in the gap, and the centering action as a result of the force produced by the oil pressure and acting radially on the impact piston.

In the case of the embodiment according to FIG. 4 the diameter of the impact mechanism guide surface 36 is not increased linearly relative to the distance from the transition point 46, at which the cylindrical region Z ends, but over-proportionally whereby a parabolic path is produced inside the region P with a tangential transition in the region Z.

The diameter change in the region P results from:

D(a)=DZ+(k·a²), with

DZ=diameter of the impact mechanism guide surface in the cylindrical region of the guide surface,
K=constant factor, which is selected dependent on the axial extension of the widened guide region P. This factor influences how severely the diameter changes per axial position change a.
a=axial distance of a plane lying perpendicular to the axis of symmetry, from the transition point 46, wherein the plane lies within the region P.

The length of the region P divided by the total length of the guide region (Z+P) amounts to 0.5 in the illustrated design. The guide region can also have a continuously parabolically increasing diameter, but a ratio of 0.3 to 0.9, preferably 0.5 to 0.7, has emerged as the preferred design.

The sum of the difference between the diameter DZ in the region Z with a constant diameter and the diameter DM at the end of the region at which the diameter change reaches its maximum, amounts to 0.01 to 0.08, preferably 0.02 mm to 0.05 mm.

The factor k can be calculated according to the formula

k=(DM−DZ)/(P²)

when the axial length P of the region with variable diameter and the maximum diameter change (DM-DZ) are predetermined.

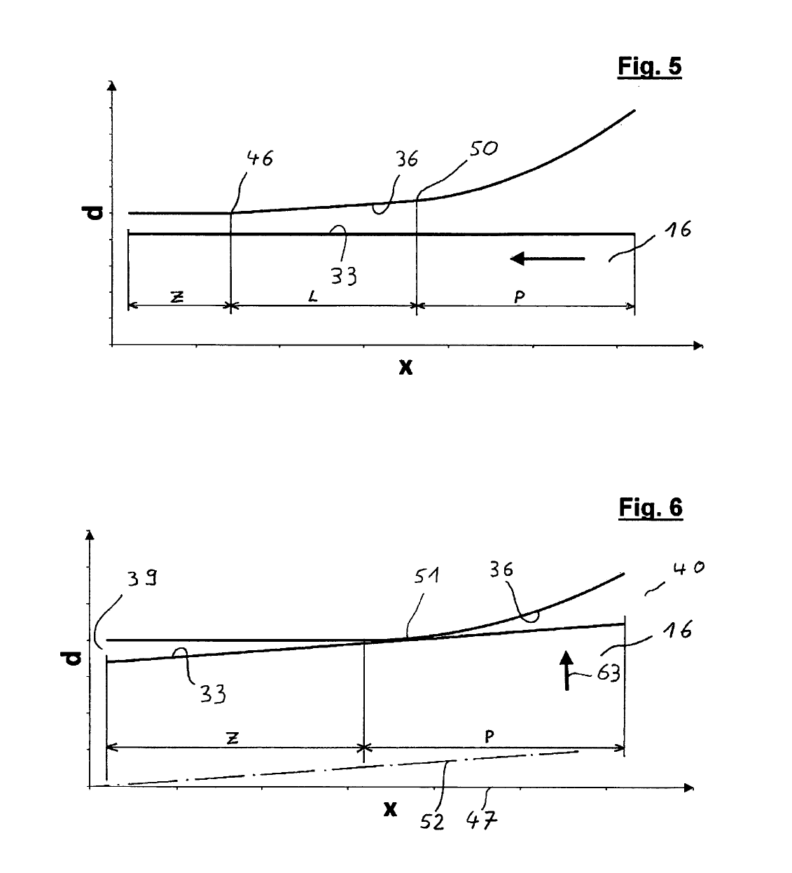

In the case of the embodiment according to FIG. 5 the configurations according to FIG. 3 are combined with those of FIG. 4. The region Z with a constant diameter of the impact mechanism guide surface is adjoined from the transition point 46 by a region L with a linearly increasing diameter up to the second transition point 50 from where a region P follows with a parabolically increasing diameter.

The transition from the cylindrical to the linearly increasing diameter can be provided in the region of the transition point 48 with a radius so that no corner or no edge arises in the path of the contour, but a tangential transition is produced.

It is also possible to design the diameter change of the guide region so that the region Z with a constant diameter of the impact mechanism guide surface is adjoined from the transition point 48 by a region P with parabolically increasing diameter and from the second transition point 50 by a region L with linearly increasing diameter.

FIG. 6 shows a further concrete embodiment of an impact mechanism guide surface. This design corresponds to that illustrated in FIG. 4, but here the position of the impact piston guide surface 33 is shown that is produced when the impact piston stands so obliquely in the receiving bore that the impact piston guide surface comes to bear against the impact mechanism guide surface. With such an oblique position the axis of symmetry 52 of the impact piston, which is here shown as a chain-dotted line, no longer runs parallel to the axis of symmetry 47 of the receiving bore of the impact mechanism housing that is shown by the horizontal coordinate axis, and the region shown on the right of the impact piston guide surface is displaced in the direction of the arrow 63 toward the impact mechanism guide surface 36. The inclined position has the result that contact occurs between the impact piston guide surfaces and the impact mechanism guide surfaces, wherein the impact piston guide surface 33 of the piston rod 16 comes to bear against the outer end of the impact mechanism guide surface 36. Such a situation can occur by way of example in the event of extremely high transverse forces acting on the impact piston at which the load-bearing capacity of the lubricating film is exceeded or in the event of low impact piston speeds at which no sufficiently stable lubricating film can form in the gap between the guide surfaces and an exact centering is no longer provided.

Through the parabolic path of the contour of the impact mechanism guide surface in the region P, in the event of an oblique position it does not result in contact between the outer angular edge of the impact mechanism guide surface 36 and the impact piston guide surface 33, but the contact region 51 lies in the parabolic region P. Through this parabolic rounded area in the region P the contact surface is increased whereby the surface pressure in the contact region is considerably reduced, which reduces considerably damage and wear to the guide surfaces. In the case of a purely cylindrical design of the impact mechanism guide surface the outer pointed edge of the impact mechanism guide surface would come to bear against the impact piston guide surface, so that high surface pressures and wear would result. Also with a linear diameter change instead of the parabolic change, as shown in FIG. 3, angular edges would be present at the outer end of the impact mechanism guide surface and also at the transition point between the cylindrical region and the region in which the diameter changes linearly relative to the distance from the transition point, and these angular edges would lead to high surface pressures and thus to damage to the guide surfaces and increased wear.

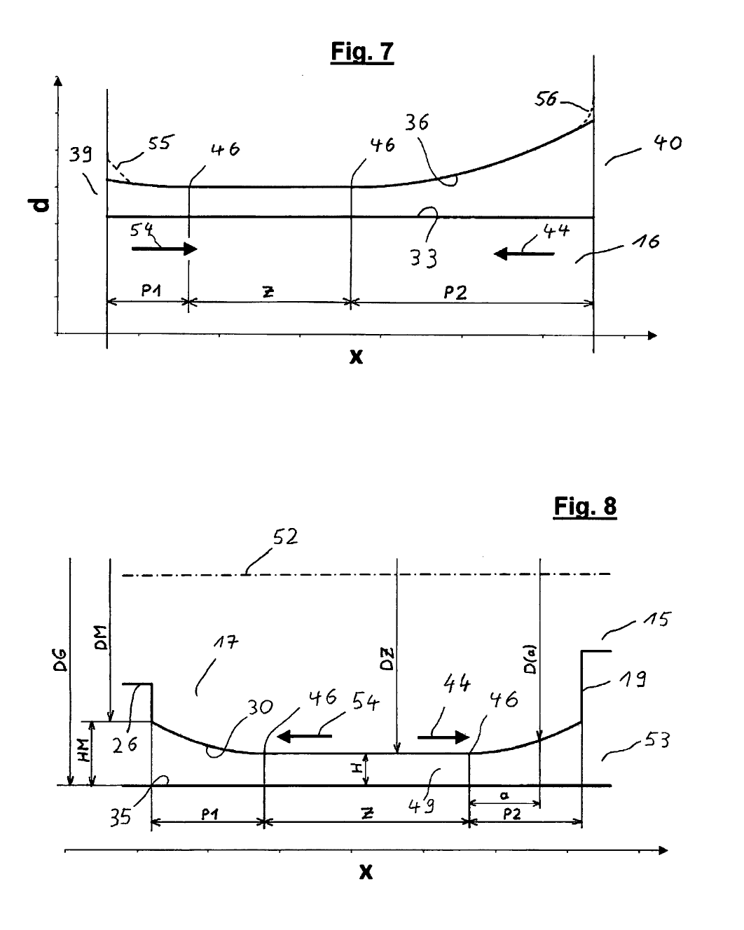

The concrete embodiment according to FIG. 7 is similar to that shown in FIG. 4, but the impact mechanism guide surface 36 has on each side of the cylindrical region Z, or at both ends of the impact mechanism guide region, regions P1 and P2 with parabolically increasing diameter so that an improvement in the load-bearing capacity of the lubricating film is achieved in both directions of movement 44, 54 of the impact piston 16 through a lubricating gap height that changes in the axial direction. The lengths of the regions P1 and P2, and the maximum diameter changes can be adapted to conditions and can have different parameters in the regions P1 and P2.

If the impact piston moves in the direction of the arrow 44, then the parabolic region P2—and in the opposite direction of movement corresponding to arrow 54 the parabolic region P1—causes an improved build-up of pressure in the gap between the guide surfaces by oil being transported from the surface of the impact piston guide surface into the gap that is narrowing in the corresponding direction of movement. At the outer ends of the guide surface adjoined by the pressure compensating groove or the lower drive chamber and where the diameter clearly changes, additionally chamfers 55 or radii 56 can be provided that are illustrated by way of example by dotted lines. These chamfers or radii make it easier to install the impact piston in the receiving bore of the impact mechanism housing since they serve as guide aids and center the impact piston with a slight lateral stagger relative to the impact mechanism housing. Furthermore these radii or chamfers reduce the risk that the sharp edges that are present without radii or chamfers would be damaged and displaced when stressed. The axial extension of the chamfers or radii is smaller than the axial extension of the parabolic region P. In contrast to the illustration the diameter difference within the region of the chamfers or the radii is greater than the diameter difference within the parabolic region P.

FIG. 8 shows a further embodiment of an impact piston guide surface. Here the guide region and the lubricating gap 49 in the region of the piston collar 17 are shown. Compared with FIGS. 3 to 7, in this design, the impact piston guide surface 30 has a contour with a changing diameter, and the impact mechanism guide surface 35 is cylindrical in design.

The contours of the impact piston guide surface 30 and the impact mechanism guide surface 35 are shown wherein the FIG. shows a section through the impact piston axis 52 and only one half of the contours that are symmetrical to the impact piston axis 52 is shown. The contours represent only one section that is restricted in the direction of the impact piston axis.

The vertical distance between the impact piston axis, or axis of symmetry 52, and the thick contour lines of the impact piston guide surface 30, or impact mechanism guide surface 35, represents the radius of the impact piston or of the receiving bore of the impact mechanism housing.

The axial extension of the guide region is shown on the horizontal coordinate axis. The radii, the diameters, the diameter change, the gap height, the axial extension of the guide surfaces and the position of the transitions from the cylindrical region Z to the widening regions P1, P2, do not correspond to the parameters advisable in practice. Rather, the parameters are shown enlarged and not true to scale for better illustration.

The lower thick line represents the contour of the impact mechanism guide surface 35 within a partial region between the upper drive chamber 53 and the lower drive chamber 39. The impact mechanism guide surface has a constant diameter DG inside this region.

The upper thick line represents the contour of the impact piton guide surface 30, in the region of the upper piston collar 17.

Inside a central axial region Z the impact piston guide surface is designed cylindrically, i.e. the diameter DZ, or the distance of the line from the axis of symmetry, is constant up to the two transition points 46. Inside the regions P1, P2 the outer diameter of the impact piston guide surface decreases over-proportionally to the distance from the transition points 46 and reaches its minimal diameter DM at the ends of the impact mechanism guide surface. The gap height results from half the difference between the diameter of the impact mechanism guide surface and the impact piston guide surface and is marked in region Z by H. The gap height assumes the maximum value HM at the outer ends of the impact piston guide surface.

The end of the impact piston guide surface 30 of the piston collar 17 shown on the right is adjoined by the upper piston rod 15 that projects into the upper drive chamber 53 in which the upper drive face 19 is located. The left end is adjoined by the peripheral groove 26.

The diameter change in the regions P1, P2 results from the formula:

D(a)=DZ−(k·a²), with

DZ=diameter of the cylindrical region of the impact piston guide surface,
k=constant factor that is selected dependent on the axial extension of the widening guide region P. This factor affects how severely the diameter changes per axial position change a.
a=axial distance of a plane lying perpendicular to the axis of symmetry from the transition point 46, wherein the plane lies within the region P.

The length of the regions P1, P2 divided by the total length of the guide region (Z+P1+P2) amounts in the illustrated embodiment to about 0.27. A ratio of the length of the region P to the overall length of the impact piston guide region of 0.1 to 0.4, preferably 0.2 to 0.3 has emerged as the preferred design.

The sum of the difference between the diameter DZ in the region Z with a constant diameter and the diameter DM at the outer end of the region P at which the diameter change reaches its maximum, amounts to 0.005 mm to 0.03 mm, preferably 0.01 mm to 0.02 mm.

The factor k results from

k=(DZ−DM)/(P²),

when the axial length P of the region with variable diameter and the maximum diameter change (DZ-DM) are predetermined.

The arrow 44 designates the return stroke movement of the impact piston and thus of the piston collar 17 parallel to the axis of symmetry, during which the parabolic contour inside the region P2 creates an improvement in the load-bearing capacity of the lubricating film. As a result of the adhesion forces, oil located in the gap remains adhering on the surface of the impact mechanism guide surface, which moves relative to the impact piston, and is drawn into the narrowing lubricating gap against the direction of the arrow 44, which leads to a rise in the pressure inside the gap. This increased oil pressure in the gap leads to an improved load-bearing capacity of the oil lubricating film and improves the centering action as a result of the force generated by the increased oil pressure and acting radially on the impact piston. Instead of the parabolic contour the contour can be also be designed analogously with the design according to FIG. 3 so that the diameter of the impact piston guide surface changes linearly relative to the distance from the transition point 46 wherein a parabolic contour further increases the load-bearing capacity of the lubricating gap compared with a linear contour, and further reduces the wear.

The embodiment according to FIG. 9 corresponds to the configuration according to FIG. 8, wherein here the position of the impact piston guide surface 30 is illustrated that arises when the impact piston is set so obliquely in the receiving bore of the impact mechanism housing that the impact piston guide surface 30 comes to bear against the impact mechanism guide surface 35. In the case of such an oblique position the axis of symmetry 52 of the impact piston no longer runs parallel to the axis of symmetry 57 of the receiving bore of the impact mechanism housing and the end shown at the right of the impact piston guide surface is displaced in the direction of the arrow 63 toward the impact mechanism guide surface. The inclined position leads to contact between the impact piston guide surfaces and the impact mechanism guide surfaces wherein the impact piston guide surface 30 of the piston collar 17 comes to bear against the impact mechanism guide surface 35 close to the outer edge of the piston collar. Such a situation can occur by way of example in the event of extremely high transverse forces acting on the impact piston at which the load-bearing capacity of the lubricating film is exceeded, or in the case of low impact piston speeds at which no sufficiently stable lubricating film can form and an exact centering is no longer provided.

For the purpose of improved illustration, the inclined position as well as the diameter change are not shown true to scale in the illustration, but are highly exaggerated and do not correspond to the parameters advisable in practice.

Through the parabolic path of the contour of the impact piston guide surface in the region P, where the diameter of the impact piston guide surface reduces increasingly toward the outer end of the impact piston guide surface, in the event of an inclined position it does not result in contact of the outer angular edge of the impact piston guide surface with the impact mechanism guide surface, but the contact region lies in the parabolic region P. Through this parabolic rounded area in the region P the contact surface is enlarged, whereby the surface pressure in the contact region is considerably reduced, which severely reduces damage and wear on the guide surfaces. In the case of a purely cylindrical design of the impact piston guide surface the outer pointed edge would come to bear, which would result in high surface pressures and wear. Even with a linear diameter change instead of a parabolic diameter change, similar to the contour according to FIG. 3, angular edges would be present at the outer end of the impact piston guide surface as well as at the transition point from the cylindrical region to the region in which the diameter reduces linearly relative to the distance from the transition point, and these angular edges would lead to high surface pressures and thus to damage to the guide surfaces and to increased wear.

It is also possible to provide the diameter change at the impact piston guide surface, more particularly with a parabolic path, only at the respective ends of the respective impact piston guide surfaces pointing toward the piston rods. Thus in the illustrated design a diameter change could be designed at the collar 17 by way of example only at the end pointing toward the rod 15 (in the region P2).

FIG. 10 shows a section of the impact mechanism housing in the region of the impact mechanism guide surface 36 that serves for guiding the piston rod 16 of the impact piston. The chain-dotted line represents the line of symmetry 52 of the impact piston and the receiving bore 25 of the impact mechanism housing. Pressure compensating grooves 58 are provided on the impact mechanism guide surface 36 and run peripherally at approximately the same spacing relative to one another to ensure that the pressure prevailing in the gap between the impact mechanism guide surface 36 and the impact piston guide surface is compensated in the peripheral direction so that the pressure acting radially on the piston causes no transverse deflection of the impact piston in relation to the receiving bore. The pressure compensating grooves can however not prevent contact occurring between the guide surfaces of the impact piston and impact mechanism in the event of low relative speed between the impact piston and impact mechanism or in the event of a high transverse force acting on the impact piston.

The impact piston guide surfaces at the piston collars 17, 18, and the impact mechanism guide surfaces can have peripheral pressure compensating grooves wherein it is also possible that both impact piston guide surfaces and also impact mechanism guide surfaces are designed with pressure compensating grooves. These pressure compensating grooves can also be arranged in the region L or P, in which the diameter of the guide surface changes linearly or parabolically.

Furthermore a pressure relief groove 40 and three sealing grooves 41 are shown lying behind the guide region, seen in the impact stroke direction.

FIGS. 11a to 11d show detail views of the pressure compensating grooves 58. In particular cross sections are shown whose cross-sectional plane runs parallel to the axis of symmetry 52 of the receiving bore 25 of the impact mechanism housing. The illustrations show only a section of the overall cross section. The illustrated pressure compensating grooves differ in their cross-sectional shape especially in the transition from the impact mechanism guide surface 36 to the groove flank surfaces 59.

The axis of symmetry of the receiving bore is not shown, but runs horizontally above the illustrated contour, like the impact piston guide surface that is not shown but that lies horizontally between the axis of symmetry and the impact mechanism guide surface 36.

The transition from the impact mechanism guide surface to the groove flank surfaces is thus designed so that the diameter of the impact mechanism guide surface close to the pressure compensating groove increases with decreasing distance toward the groove flank surfaces. Through this diameter change the transition can adopt the form of a slope with linear path and small incline, a slope with parabolic path, a chamfer or a radius, wherein combinations of chamfers or radii with slopes are also possible.

The designs of the pressure compensating grooves described below show pressure compensating grooves on the impact mechanism guide surface 36. The same designs can also be provided on the impact mechanism guide surfaces 34 and 35 and the impact piston guide surfaces 32 and 33, but preferably on the impact piston guide surfaces 30 and 31.

The cross section of a pressure compensating groove 58 according to FIG. 11a in a plane parallel to the axis of symmetry of the receiving bore of the impact mechanism housing has a radius R in the groove bottom so that the groove bottom changes tangentially into the groove flank faces 59. The diameter D of the impact mechanism guide surface 36 increases slightly linearly with decreasing distance to the groove flank surfaces so that the contour of the impact mechanism guide surface in this region forms a slope 62 with slight pitch on each side of the groove flank surfaces 59.

The slopes support the pressure build-up in the lubricating gap between the impact mechanism guide surface and the impact piston guide surface and furthermore prevent damage to the sensitive groove edges 61 since they are spaced slightly from the impact piston guide surface through the slopes. The groove is designed symmetrically so that the contour of the slopes is provided on both sides of the pressure compensating groove. It is also possible to design only one side with a slope. The slopes can also be made with a parabolic contour with tangential transition to the impact mechanism guide surface.

The radius at the groove bottom amounts to between 0.75 mm and 1.75 mm, the distance between the groove flanks amounts to between 1.5 mm and 3.5 mm. The groove depth amounts to between 0.8 mm and 3 mm.

In comparison with this, in the embodiment according to FIG. 11b the diameter change is substantially greater whereby slopes are provided at the groove edges in the form of chamfers with a pitch of about 45°. The groove edges 61 thus formed at the transition of the slopes to the groove flank surfaces are significantly more stable to stresses that can arise through mechanical contact, cavitation or flow forces. Flow forces and cavitation can appear when oil flows with a high flow speed out from the gap between the guide surfaces and into the pressure compensating grooves. The groove depth is selected so that the slopes change directly into the radius R of the groove bottom.

Cavitation means the process when by way of example vortices arise at the edges where oil is flowing fast round same and these vortices produce locally a sharp drop in pressure so that gas bubbles can form in the oil. If these gas bubbles pass into regions with higher pressure, these gas bubbles collapse again whereby the fluid is accelerated very strongly around the gas bubbles. If the collapse of the gas bubbles takes place close to surfaces of the component parts, more particularly close to the angular edges, then the accelerated oil can strike the surfaces of the component parts so hard that these become damaged.

In comparison with the design according to FIG. 11b, in the configuration according to FIG. 11c the slopes or chamfers are replaced by radii R so that the groove surfaces merge into one another and there are no more angular edges, but tangential transitions between the impact mechanism guide surface and the inside faces of the pressure compensating grooves. The radii in the groove bottom and at the transitions can be the same or different. Through the rounded area stable edges and transitions are provided that furthermore reduce the vortices of the oil flowing into the pressure compensating groove, and thus reduce the tendency for cavitation.

Finally in the embodiment according to FIG. 11d compared with the design according to FIG. 11c the pressure compensating groove has at the transitions 60 shoulders 63 whereby a stepped pressure compensating groove with inclined groove flank surfaces 59 is produced. The groove bottom has a radius R. The transitions between the groove flank surfaces 59 and the shoulder 63 are likewise provided with radii so that no angular groove edges are present. Through the shoulder the flow of oil that flows from the gap between the impact piston guide surface and the impact mechanism guide surface into the pressure compensating groove, is to be deflected so that the swirl and flow speed are reduced in the groove bottom and the pressure reduction between the oil pressure in the gap and the oil pressure in the pressure compensating groove takes place stepwise. The distance of the impact mechanism guide surface 36 from the bottom of the pressure compensating groove divided by the distance between the impact mechanism guide surface 36 and the shoulder 63 amounts to 0.25 mm to 0.5 mm.

1. An impact tool with an impact mechanism housing having a receiving bore in which an impact piston is mounted such that it is movable along the longitudinal axis, wherein at least one impact mechanism guide surface having an inner diameter is formed in the receiving bore and at least one impact piston guide surface having an outer diameter is formed on the impact piston, wherein the impact mechanism guide surface has in the axial direction at least in regions an inner diameter that increases non-linearly and/or that the impact piston guide surface has an outer diameter that decreases non-linearly in the axial direction.

2. The impact tool as claimed in claim 1, wherein the inner diameter of the impact mechanism guide surface has a diameter that increases non-linearly toward at least one of the ends.

3. The impact tool as claimed in claim 2, wherein the impact mechanism guide surface guides a piston rod wherein the inner diameter of the impact mechanism guide surface has a diameter that increases non-linearly toward the outer end of the piston rod.

4. The impact tool as claimed in, claim 1 wherein the non-linear increase in the inner diameter of the guide impact mechanism guide surface is parabolic in design.

5. The impact tool as claimed in, claim 1 wherein the impact mechanism guide surface has several partial regions wherein one partial region has a non-linearly changing inner diameter that merges into one partial region with a constant inner diameter.

6. The impact tool as claimed in, claim 1 wherein at the end of the partial region having the largest diameter there is a partial region arranged with a linearly widening inner diameter, and at the end of the partial region having the smallest diameter there is a partial region arranged with a constant diameter.

7. The impact tool as claimed in, claim 1 wherein the impact mechanism guide surface has on each side partial regions that have partial regions widening non-linearly in different orientation, wherein the partial regions and are preferably connected to one another via a partial region with a constant diameter.

8. The impact tool as claimed in claim 1, wherein the impact piston has at least one piston rod and at least one piston collar whose outside surfaces are designed as impact piston guide surfaces.

9. The impact tool as claimed in claim 8, wherein at least one impact piston guide surface has on the side facing away from the tool an outer partial region having a non-linearly decreasing outer diameter that preferably runs parabolically and/or preferably changes into a partial region with a constant diameter.

10. The impact tool as claimed in claim 9, wherein the impact piston guide surface has two outer partial regions that have outer diameters that decrease non-linearly in different orientation and preferably run parabolically.

11. The impact tool as claimed in, claim 8 wherein a partial region with a constant diameter is arranged between the outer partial regions.

12. The impact tool as claimed in, claim 1 wherein the impact mechanism has an impact mechanism guide surface that guides a piston rod, wherein a tool can be loaded with the outer end of the piston rod, and wherein the inner diameter of the impact mechanism guide surface has a partial region with a constant diameter and pointing toward the outer end of the piston rod, a partial region with a parabolically increasing diameter, and that at least one impact piston guide surface has a partial region with a constant diameter and on the side facing away from the tool an outer partial region having a parabolically decreasing outer diameter.

13. The impact tool as claimed in, claim 1 wherein the impact mechanism guide surface is adjoined at least by a region in which there are peripheral grooves arranged wherein the webs between the grooves and the region between a groove and a space arranged behind same have an inner diameter that is greater than the smallest inner diameter of the guide region.
